(19) United States
(12) Patent Application Publication
(10) Pub. No.: US 2015/0122762 A1
(43) Pub. Date: May 7, 2015

(54) Self-Propelled Type Crane

(71) Applicant: Ho-Ryong Co., Ltd., Gimje-si (KR)

(72) Inventors: Yong HONG, Jeonju-si (KR); Yong gil KIM, Gimje-si (KR)

(73) Assignee: HO-RYONG CO., LTD., Gimje-si (KR)

(21) Appl. No.: 14/195,769

(22) Filed: Mar. 3, 2014

(30) Foreign Application Priority Data
Nov. 7, 2013 (KR) 10-2013-0134583

(51) Int. Cl. B66C 23/36; B66C 23/80; B66C 13/54; B60K 6/00; B66C 23/00; B60L 11/18; B66C 13/00

(52) U.S. Cl. CPC B66C 23/36; B60L 11/1809; B66C 23/80; B66C 13/00; B60K 6/00; B66C 23/54; B66C 13/54
USPC 212/291; 180/65.21

(57) ABSTRACT

The present invention relates to a self-propelled type crane that has outriggers, provided at both ends of the front area and both ends of the rear area of the vehicle body, inclined downward from the top to the outside, thereby helping simply manufacture each outrigger with one cylinder, helps prevent each outrigger from falling down while the crane is operated to lift heavy loads, reduces electrical loss by operating only one of the electric motors and one of the hydraulic pumps when a small amount of power for operation is needed, and increases power output by using both the two electric motors and the two hydraulic pumps when a large amount of power for operation is needed.

### FIELD OF THE INVENTION

The present invention relates to a self-propelled type crane. More particularly, the present invention relates to a self-propelled type crane having each outrigger inclined, thereby preventing each outrigger from falling down while the crane operates to lift heavy loads, reducing a loss of electricity when a small amount of power for operation is needed, and increasing power output when a large amount of power for operation is needed.

### BACKGROUND

Generally, a crane is provided in a cargo box of a vehicle and used to lift a heavy load. In addition, cargo trucks that are powered by an internal combustion engine are used as a vehicle on which a crane is mounted. Meanwhile, when a crane that is mounted on a vehicle powered by an internal combustion engine as described above is used inside a plant or construction site, a problem arises since exhaust gas and noise pollute the interior environment.

Therefore, “Crane mounted on the electric vehicle” of Korean Utility Model Application Publication No. 2009-0000097 (Jan. 7, 2009) (hereinafter, “conventional crane mounted on the electric vehicle”) is disclosed for solving the above problem.

The conventional crane mounted on the electric vehicle comprises an electric vehicle that includes an electric motor powered by a battery, and a driving device unit powered by the electric motor; a crane unit that includes a post rotatably mounted on the electric vehicle, and a boom assembly having a plurality of telescopically extendable and retractable booms and one end of which is connected by a hinge to the top of the post; and a crane operation unit that includes a hydraulic pump that is powered by the electric motor and pressurizes and discharges a hydraulic fluid, a boom tilting cylinder that extends and retracts by the hydraulic fluid pressurized by the hydraulic pump, one end of which is connected by a hinge to the post, and the other end of which is connected by a hinge to the boom assembly, thereby tilting the boom assembly, a boom cylinder that is provided within the boom assembly and extends and retracts by the hydraulic fluid pressurized by the hydraulic pump, thereby extending and retracting the boom, a swing motor that rotates by the hydraulic fluid pressurized by the hydraulic pump, thereby rotating the post with respect to the electric vehicle, and a first crane manipulating unit that controls the hydraulic fluid discharged by the hydraulic pump and supplied to the boom tilting cylinder, the boom cylinder, and the swing motor.

Additionally, a hook connected by a chain is connected to the other end of the boom assembly. Furthermore, a front outrigger that is capable of extending and retracting and provided in the front area of the electric vehicle, thereby supporting the front load of the electric vehicle, a rear outrigger that is capable of extending and retracting and provided in the rear area of the electric vehicle, thereby supporting the rear load of the electric vehicle, an outrigger cylinder that extends and retracts by the hydraulic fluid pressurized by the hydraulic pump, thereby extending and retracting the front and rear outriggers, an outrigger jack-up cylinder that extends and retracts by the hydraulic fluid pressurized by the hydraulic pump, thereby moving up and down the front and rear outriggers, and an outrigger manipulating unit that controls the hydraulic fluid discharged by the hydraulic pump and supplied to the outrigger cylinder and the outrigger jack-up cylinder, are provided.

Meanwhile, the conventional crane mounted on the electric vehicle described above have the following problems.

First, each of the front and rear outriggers that constitute the conventional crane mounted on the electric vehicle needs to have two cylinders: an outrigger cylinder and an outrigger jack-up cylinder. Therefore, each of the front and rear outriggers has a complicated structure and is costly to manufacture.

Furthermore, a jack-up cylinder that constitutes the conventional outriggers is vertically disposed and therefore has a problem of being easily bent to cause the crane to fall down frequently while the crane is operated to lift heavy loads.

Furthermore, when the electric vehicle on which the conventional crane mounted moves, a driver stands up and drives the electric vehicle, which frequently causes a problem of falling of the driver while driving the electric vehicle.

### SUMMARY OF THE INVENTION

Therefore, the present invention is provided to solve the problems of the above conventional technology.

The object of the present invention is to provide a self-propelled type crane that has outriggers, provided at both ends of the front area and both ends of the rear area of the vehicle body, inclined downward from the top to the outside, thereby helping simply manufacture each outrigger with one cylinder, helping prevent each outrigger from falling down while the crane is operated to lift heavy loads, and helping easily manufacture front and rear recharging units by providing an internal support plate that bends inside at the lower end of the vertical frames that are provided at both ends of and constitute the vehicle body frame.

Another object of the present invention is to provide a self-propelled type crane that includes two hydraulic pumps, within a fluid tank, that are connected by fluid lines to a wheel driving motor, a rotation driving unit, an angle changing cylinder, a boom extension and retraction cylinder, a winch, and each of the outriggers, and two electric motors, at the top of the fluid tank, that are directly connected to the rotation shaft of each of the hydraulic pumps, thereby reducing electrical loss by operating only one of the electric motors and one of the hydraulic pumps when a small amount of power for operation is needed, and increasing power output by using the two electric motors and the two hydraulic pumps when a large amount of power for operation is needed.

Yet another object of the present invention is to provide a self-propelled type crane that prevents an accident of a driver falling down while driving, with the driver driving the vehicle body while seated at the driving seat, and enables easy control of the output with an accelerator pedal installed at the driving seat, thereby controlling the rotative force of the electric motor.

Still another object of the present invention is to provide a self-propelled type crane that stores a lot of storage batteries with front and rear recharging units installed at the front and rear area of the vehicle body.

In an effort to achieve the above objectives, a “self-propelled crane” according to the present invention may include: a vehicle body having a body frame that is provided along a front-rear direction within the vehicle body, two front wheels that are provided at both sides of the front area and rotated by a wheel driving motor, and two rear wheels that are provided at both sides of the rear area and steered by a steering device, wherein the body frame includes two vertical frames that are provided in parallel at both sides and a plurality of horizontal frames that connect the lower parts of the vertical frames at both sides, each of the vertical frames including an internal support plate protruding horizontally and inwardly from the lower end and an outer protrusion plate protruding outwardly from the upper end; a crane having a boom support that is mounted on the center of the body frame and can be rotated by a rotation driving unit, a boom that has a rear end connected to the boom support so that an angle can be changed by an angle changing cylinder and includes a boom extension and retraction cylinder and a winch, and a hook wire that is wound around the winch and released downward from the front end of the boom and includes a hook at the end; a front recharging unit that is disposed at the front area between the vertical frames at both sides and on which a lot of rechargeable batteries are mounted; a rear recharging unit that is disposed at the rear area between the vertical frames at both sides and at the upper part of the rear area of the vehicle body, and on which a lot of rechargeable batteries are mounted; a plurality of outriggers that are provided at both sides of the front and rear areas of the body frame, and each of which is inclined downward from the top to the outside; a hydraulic fluid supply unit that is disposed at the center of one side of the vehicle body and supplies a hydraulic fluid to the wheel driving motor, the rotation driving unit, the angle changing cylinder, the boom extension and retraction cylinder, the winch, and each of the outriggers; and a driving seat that is disposed at the center of the other side of the vehicle body and in which a driver is able to sit to manipulate and control the wheel driving motor, the rotation driving unit, the angle changing cylinder, the boom extension and retraction cylinder, the winch, each of the outriggers, and the hydraulic fluid supply unit.

In addition, the outrigger of the “self-propelled type crane” according to the present invention may include a cylinder that is inclined with respect to and fixed to the vehicle body and has a rod protruding from the lower part, and a contact plate that is coupled by a hinge shaft to the lower part of the rod so that the angle can be changed and that contacts the road surface.

Furthermore, the hydraulic fluid supply unit of the “self-propelled type crane” according to the present invention may include a mounting space that is formed at a central part of one side of the vehicle body and is indented so that the outer and upper parts are open, a fluid tank that is insertedly mounted into the mounting space, two hydraulic pumps, within the fluid tank, each of which is connected by fluid lines to the wheel driving motor, the rotation driving unit, the angle changing cylinder, the boom extension and retraction cylinder, the winch, and each of the outriggers, and two electric motors, at the top of the fluid tank, that are directly connected to the rotation shaft of each of the hydraulic pumps and are connected to the driving seat so that the electric motors are provided with electricity from the front recharging unit or rear recharging unit by external manipulation, and a cover material that covers the outer and upper parts of the mounting space by opening and closing.

Furthermore, the driving seat of the “self-propelled type crane” according to the present invention may include a driving space that is formed at a central part of the other side of the vehicle body so that the outer and upper parts are open, a seat that is provided at the driving space and at which a driver sits while looking ahead, a steering wheel that is provided at the front part of the driving space and connected to the steering device, a manipulation and control unit that is provided within the driving space and manipulates and controls the wheel driving motor, the rotation driving unit, the angle changing cylinder, the boom extension and retraction cylinder, the winch, each of the outriggers, and the two electric motors, an accelerator pedal may be provided at the lower part of the driving space to control the rotative force of the electric motor, and an upper safety cover that covers the upper part of the driving space.

Furthermore, the front recharging unit of the “self-propelled type crane” according to the present invention may include a front support plate that has both ends fixedly contact the upper part of the internal support plate of the vertical frames at both sides and stores a lot of rechargeable batteries at the upper part, and a cover plate that covers the upper part between the vertical frames at both sides.

Furthermore, the rear recharging unit of the “self-propelled type crane” according to the present invention may include a rear support plate that has both ends fixedly contact the upper part of the internal support plate of the vertical frames at both sides, two rear horizontal side plates that have each end fixed on the upper surface of the outer protrusion plate of the vertical frames at both sides, are fixed to the vertical frames at both sides in an outward horizontal direction, and store a lot of rechargeable batteries at the upper part, and a rear cover material that is provided at the upper part of the rear area of the vehicle body and covers the rechargeable batteries that are loaded. The rear cover material is configured to open and close, and is in the shape of a rectangular parallelpipe with a lower part open.

As described above, the present invention has an effect of reducing a manufacturing cost of a crane by having outriggers, provided at both sides of the front area and both sides of the rear area of the vehicle body, inclined downward from the top to the outside, thereby helping simply manufacture each outrigger with one cylinder, and an effect of avoiding serious or fatal accidents by preventing each outrigger from falling down while the crane is operated to lift heavy loads, and an effect of increasing manufacturing productivity of a crane by easily manufacturing front and rear recharging units by providing an internal support plate that bends inwardly at the lower end of the vertical frames at both ends that constitute the vehicle body.

Furthermore, the present invention has an effect of reducing electrical loss by operating only one of the electric motors and one of the hydraulic pumps when a small amount of power for operation is needed, and increasing power output by using the two electric motors and the two hydraulic pumps when a large amount of power for operation is needed, by including the two hydraulic pumps, within a fluid tank, that are connected by fluid lines to a wheel driving motor, a rotation driving unit, an angle changing cylinder, a boom extension and retraction cylinder, a winch, and each of the outriggers, and two electric motors, at the top of the fluid tank, that are directly connected to the rotation shaft of each of the hydraulic pumps.

Furthermore, the present invention has an effect of providing a safer self-propelled type crane that prevents an accident of a driver falling down while driving, by having the driver drive the vehicle body while seated at the driving seat, and has an effect of providing manipulative convenience by enabling easy control of the output with an accelerator pedal installed, at the driving seat, that controls the rotative force of the electric motor.

Furthermore, the present invention has an effect of providing a self-propelled type crane that includes a front recharging unit and rear recharging unit at the front and rear areas, respectively, thereby being capable of storing a lot of storage batteries and being capable of operating for a long time after the batteries are charged once.

### BRIEF DESCRIPTION OF THE DRAWINGS

FIG. 1a shows a perspective view of a self-propelled type crane, with a top partly open, according to the present invention.

FIG. 1b shows a top perspective view of a self-propelled type crane according to the present invention, illustrating the interior.

FIG. 1c shows a schematic perspective view of a self-propelled type crane according to the present invention, illustrating front and rear recharging units installed at front and rear areas of the vehicle body.

FIG. 1d shows a cross-sectional view of a fluid tank with a cover material of a fluid supply unit removed.

FIG. 2a shows another perspective view of a self-propelled type crane according to the present invention.

FIG. 2b shows a side elevational view of a self-propelled type crane according to the present invention.

FIG. 3a shows a front perspective view of a self-propelled type crane according to the present invention, illustrating the interior.

FIG. 3b shows a cross-sectional view along line A-A of FIG. 3a.

FIG. 4a shows a rear perspective view of a self-propelled type crane according to the present invention, illustrating the interior.

FIG. 4b shows a cross-sectional view along line B-B of FIG. 4a.

### DETAILED DESCRIPTION OF THE PREFERRED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

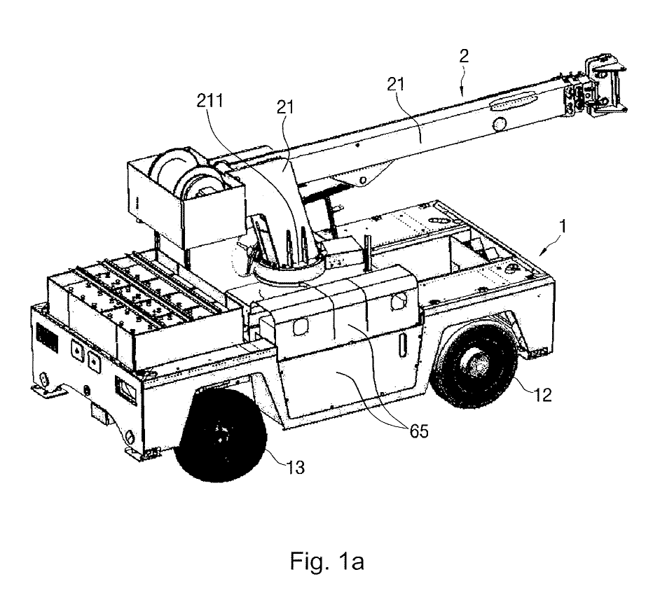

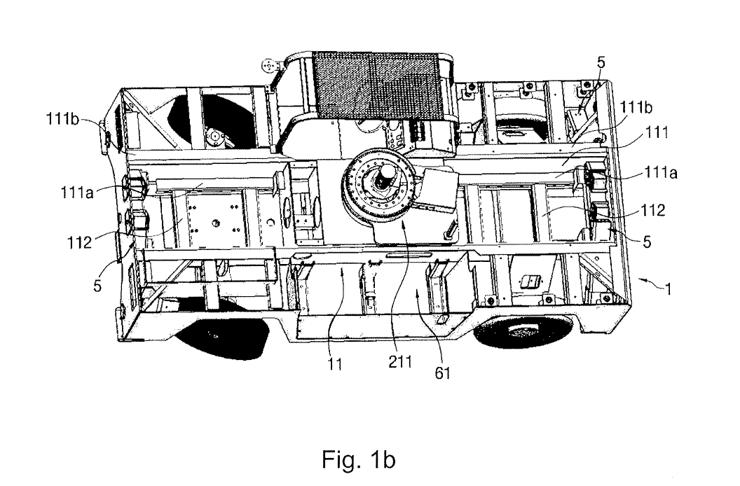

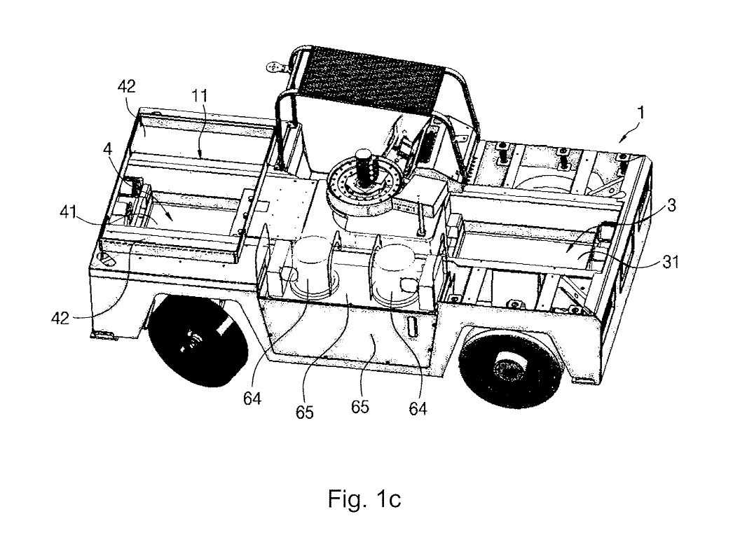

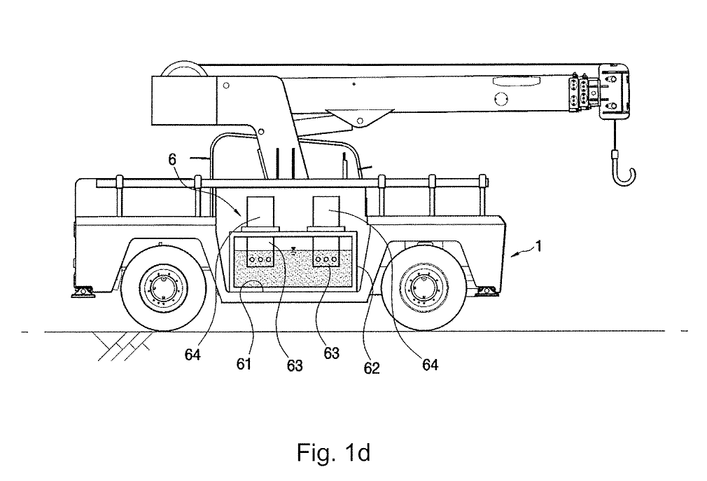

FIG. 1a shows a perspective view of a self-propelled type crane with a top partly open, according to the present invention, FIG. 1b shows a top perspective view of a self-propelled type crane according to the present invention, illustrating the interior, FIG. 1c shows a schematic perspective view of a self-propelled type crane according to the present invention, illustrating front and rear recharging units installed at front and rear areas of the vehicle body, and FIG. 1d shows a cross-sectional view of a fluid tank with a cover material of a fluid supply unit removed.

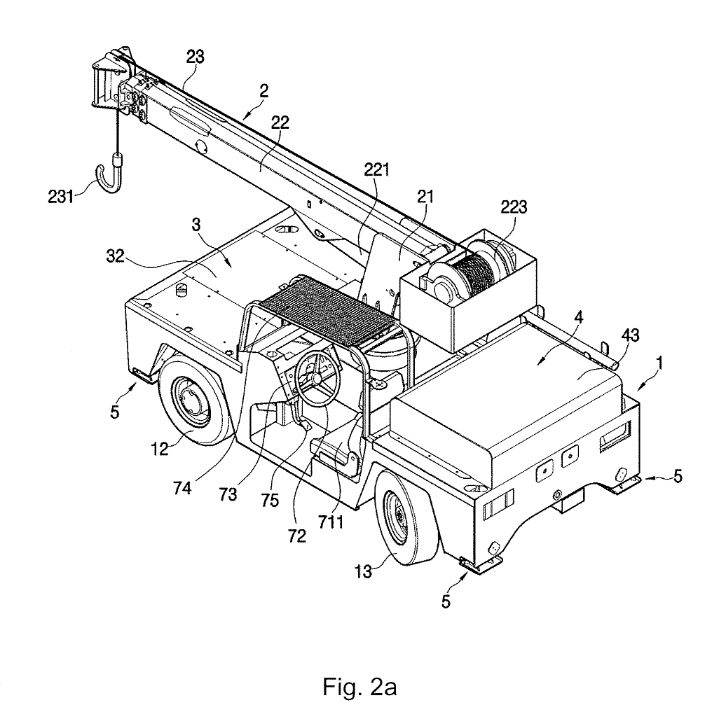

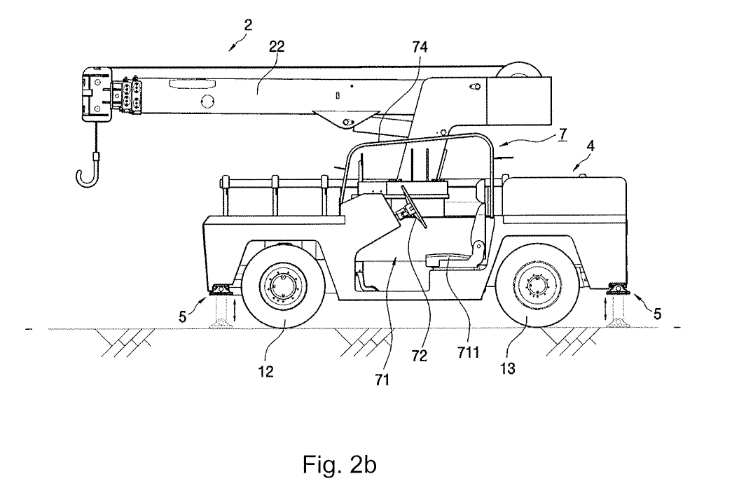

FIG. 2a shows another perspective view of a self-propelled type crane according to the present invention, and FIG. 2b shows a side elevational view of a self-propelled type crane according to the present invention.

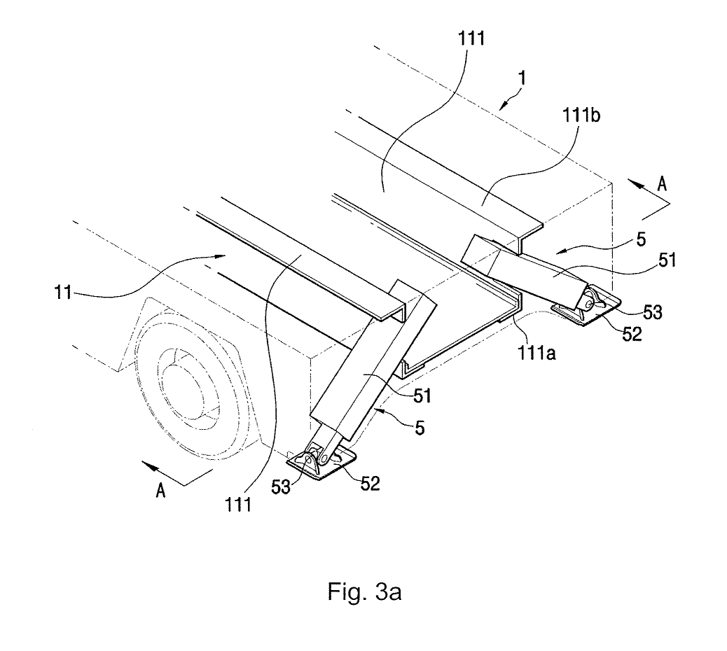

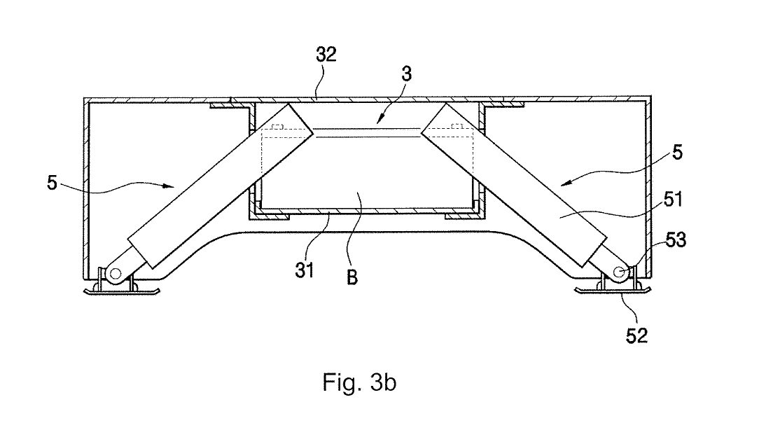

FIG. 3a shows a front perspective view of a self-propelled type crane according to the present invention, illustrating the interior, and FIG. 3b shows a cross-sectional view along line A-A of FIG. 3a.

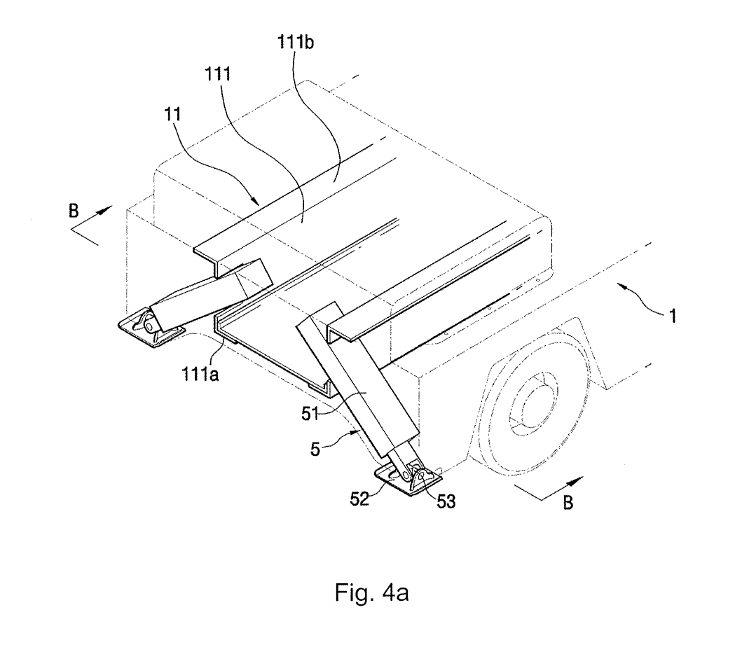

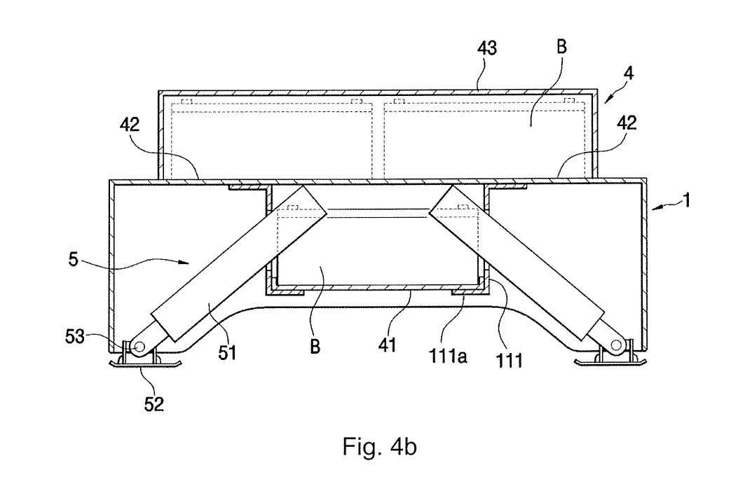

FIG. 4a shows a rear perspective view of a self-propelled type crane according to the present invention, illustrating the interior, and FIG. 4b shows a cross-sectional view along line B-B of FIG. 4a.

Referring to the drawings, a self-propelled type crane according to the present invention includes a vehicle body 1 that can be electrically driven, and a crane 2 that is provided at the central top portion of the vehicle body 1.

The vehicle body 1 includes a body frame 11 that is provided along a front-rear direction within the vehicle body, two front wheels 12 that are provided at both sides of the front area and rotated by a wheel driving motor (not shown), and two rear wheels 13 that are provided at both sides of the rear area and steered by a steering device (not shown).

The crane 2 includes a boom support 21 that are mounted on the center of the body frame 11 and can be rotated by a rotation driving unit 211, a boom 22 that has a rear end connected to the boom support 21 so that an angle can be changed by an angle changing cylinder 211 and includes a boom extension and retraction cylinder (not shown) and a winch 223, and a hook wire 13 that is wound around the winch 223 and released downward from the front end of the boom 22 and includes a hook 231 at the end.

The body frame 11 according to the present invention includes two vertical frames 111 that are provided in parallel at both sides and a plurality of horizontal frames 112 that connect the lower parts of the vertical frames 111 at both sides. Each of the vertical frames includes an internal support plate 111a protruding horizontally and inwardly from the lower end and an outer protrusion plate 111b protruding outwardly from the upper end. Furthermore, the horizontal frames 112 are fixed connected by welding to the lower ends of the vertical frames 111 at both sides.

Further, the self-propelled type crane according to the present invention includes a front recharging unit 3 that is disposed at the front area between the vertical frames 111 at both sides and on which a lot of rechargeable batteries B are mounted, a rear recharging unit 4 that is disposed at the rear area between the vertical frames 111 at both sides and at the upper part of the vehicle body 1, and on which a lot of rechargeable batteries B are mounted, a plurality of outriggers 5 that are provided at both sides of the front and rear areas of the body frame 11, and each of which is inclined downward from the top to the outside, a hydraulic fluid supply unit 6 that is disposed at the center of one side of the vehicle body 1 and supplies a hydraulic fluid to the wheel driving motor, the rotation driving unit 211, the angle changing cylinder 221, the boom extension and retraction cylinder (not shown), the winch 223, and each of the outriggers 5, and a driving seat 7 that is disposed at the center of the other side of the vehicle body 1 and in which a driver is able to sit to manipulate and control the wheel driving motor, the rotation driving unit 211, the angle changing cylinder 221, the boom extension and retraction cylinder (not shown), the winch 223, each of the outriggers 5, and the hydraulic fluid supply unit 6.

This will be described in more detail below.

The front recharging unit 3, as described above, is provided at the front area between the vertical frames 111 at both sides, and includes a front support plate 31 that has both ends fixedly contact the upper part of the internal support plate 111a of the vertical frames 111 at both sides and stores a lot of rechargeable batteries B at the upper part, and a cover plate 32 that covers the upper part between the vertical frames 111 at both sides. Additionally, it is most preferable that the cover plate 32 is coupled by a bolt to the vehicle body 1 or the vertical frames 111 at both sides so that the cover plate 32 is removable from the vehicle body 1.

The rear recharging unit 4, as described above, is provided at the rear area between the vertical frames 111 at both sides and at the upper rear part of the vehicle body 1, and includes a rear support plate 41 that has both ends fixedly contact the upper part of the internal support plate 111a of the vertical frames 111 at both sides and stores a lot of rechargeable batteries B at the upper part, two rear horizontal side plates 42 that have each end fixed on the upper surface of the outer protrusion plate 111b of the vertical frames 111 at both sides, are fixed to the vertical frames 111 at both sides in an outward horizontal direction, and the upper part of which stores a lot of rechargeable batteries, and a rear cover material 43 that is provided at the upper part of the rear area of the vehicle body 1 and covers the rechargeable batteries B that are loaded. The rear cover material 43 is configured to open and close, and is in the shape of a rectangular parallelpipe with a lower part open. Additionally, it is most preferable that the rear cover material 43 is coupled by a bolt to the vehicle body 1 so that the rear cover material 43 is removable from the vehicle body 1.

Therefore, it is easy to fix the front support plate 31 of the front recharging unit 3 and the rear support plate 41 of the rear recharging unit 4, since the internal support plate 111a that bends inwardly at the lower end of the vertical frames 111 at both sides that constitute the body frame 11. Therefore, it is one of the advantages of the present invention to more easily manufacture the front recharging unit 3 and rear recharging unit 4 using the internal support plate 111a provided at the lower end of the vertical frames 111. Furthermore, as described above, it is another advantage of the present invention to provide a self-propelled type crane that includes the front recharging unit 3 and rear recharging unit 4 at the front and rear areas of the vehicle body, respectively, thereby being capable of storing a lot of storage batteries and being capable of operating for a long time after the batteries are charged once.

Additionally, the outrigger 5 according to the present invention is inclined downward from the top to the outside, and it is most preferable that the outrigger 5 is inclined by 45° with respect to the horizon so that the vehicle body 1 can be more stably lifted using the outriggers 5. The outrigger 5 may be securely fixed to the vehicle body 5 by being connected with bolts and nuts, or may be securely fixed to the vehicle body 5 through welding.

The outrigger 5 includes a cylinder 51 that is inclined with respect to and fixed to the vehicle body 5 and has a rod protruding from the lower part of the cylinder, and a contact plate 52 that is coupled by a hinge shaft 53 to the lower part of the rod so that the angle can be changed and that contacts the road surface. The hinge shaft 53 may comprise a hinge shaft along a left-right direction, a hinge shaft along a front-rear direction, or a cross-shaped hinge shaft. The accompanying drawings illustrate a hinge shaft comprising a cross-shaped hinge shaft.

Therefore, as described above, since the outriggers 5 provided at both sides of the front area and both sides of the rear area of the vehicle body 1 are inclined downward from the top to the outside, it is one of the advantages of the present invention to easily manufacture each outrigger 5 with one cylinder 51, and to prevent each outrigger 5 from falling down while the crane 2 is operated to lift heavy loads.

The hydraulic fluid supply unit 6 according to the present invention is disposed at the center of one side of the vehicle body 1 and provided with electricity from the front recharging unit 3 or rear recharging unit 4, having a function of supplying a hydraulic fluid to the wheel driving motor, the rotation driving unit 211, the angle changing cylinder 221, the boom extension and retraction cylinder, the winch 223, and each of the outriggers 5.

The hydraulic fluid supply unit having the above described function, includes a mounting space 61 that is formed at a central part of one side of the vehicle body 1 and is indented so that the outer and upper parts are open, a fluid tank 62 that is insertedly mounted into the mounting space 61, two hydraulic pumps 63, within the fluid tank 62, each of which is connected by fluid lines (not shown) to the wheel driving motor, the rotation driving unit 211, the angle changing cylinder 221, the boom extension and retraction cylinder, the winch 223, and each of the outriggers 5, and two electric motors 64, at the top of the fluid tank 62, that are directly connected to the rotation shaft of each of the hydraulic pumps 63 and are connected to the driving seat 7 so that the electric motors 64 are provided with electricity from the front recharging unit 3 or rear recharging unit 4 by external manipulation.

Furthermore, the hydraulic fluid supply unit 6 may include a cover material 65 that covers the outer and upper parts of the mounting space 61 by opening and closing. It is most preferable that the cover material 65 is coupled by a bolt to the vehicle body 1 so that the cover material 65 is removable from the vehicle body 1.

Therefore, when a self-propelled type crane of the present invention is operated, it is possible to reduce electrical loss by operating only one of the electric motors 64 and one of the hydraulic pumps 63 when a small amount of power for operation is needed, and it is possible to increase power output of the crane 2 by using both the two electric motors 64 and the two hydraulic pumps 63 when a large amount of power for operation is needed. For example, it is possible to reduce electricity consumption by using one of the electric motors 64 when the crane 2 is driven only or only the crane 2 is operated, and it is possible to increase power output by using the two electric motors 64 when the crane 2 is driven as well as is operated.

Furthermore, the driving seat 7 according to the present invention has a function of enabling a driver to sit to manipulate and control the wheel driving motor, the rotation driving unit 211, the angle changing cylinder 221, the boom extension and retraction cylinder, the winch 223, each of the outriggers 5, and the hydraulic fluid supply unit 6.

The driving seat having the above described function, includes a driving space 71 that is formed at a central part of the other side of the vehicle body 1 so that the outer and upper parts are open, a seat 711 that is provided at the driving space 71 and at which a driver sits while looking ahead, a steering wheel 72 that is provided at the front part of the driving space 71 and connected to the steering device, and a manipulation and control unit 73 that is provided within the driving space 71 and manipulates and controls the wheel driving motor, the rotation driving unit 211, the angle changing cylinder 221, the boom extension and retraction cylinder, the winch 223, and each of the outriggers 5, and the two electric motors 64. Therefore, a driver may drive the vehicle body 1 while seated at the driving seat 7, thereby preventing an accident of the driver falling down while the vehicle body 1 is being driven.

Additionally, an accelerator pedal 75 may be provided at the lower part of the driving space 71 to control the rotative force of the electric motors 64. Therefore, easy control of power output by manipulating the accelerator pedal 75 may provide manipulative convenience.

Furthermore, an upper safety cover 74 that has a function of protecting the driver by covering the upper part of the driving seat 7 may be provided at the upper part of the driving space 74.

The operation of the present invention comprised as above will be explained below.

Referring to FIGS. 1-4, when only the vehicle body 1 according to the present invention is to be driven or a crane 2 is to be operated, it is possible to manipulate the manipulation and control unit 73 to activate one of the two electric motors 64 provided at the upper part of the fluid tank 62 and to supply a hydraulic fluid from one of the hydraulic pumps 63 so that only the vehicle body 1 is driven or the crane 2 is operated. Therefore, when only the vehicle body 1 is driven or the crane 2 is operated as above, it is one of the advantages of the present invention to be capable of minimizing electricity consumption by using only one electric motor 64.

Furthermore, when the crane 2 is operated while the vehicle body 1 is driven, the driver may manipulate the manipulation and control unit 73 provided at the driving seat 7 to activate both the two electric motors 64 provided at the upper part of the hydraulic pump 62 so that the vehicle is driven and the crane 2 is operated at the same time. Therefore, it is one of the advantages of the present invention to gain sufficient power output by using both the electric motors 64 when the vehicle body 1 is driven and the crane 2 is operated at the same time.

While a self-propelled type crane according to the present invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A self-propelled type crane comprising:
a vehicle body 1 having a body frame 11 that is provided along a front-rear direction within the vehicle body, two front wheels 12 that are provided at both sides of the front area and rotated by a wheel driving motor, and two rear wheels 13 that are provided at both sides of the rear area and can be steered by a steering device, wherein the body frame 11 includes two vertical frames 111 that are provided in parallel at both sides and a plurality of horizontal frames 112 that connect the lower parts of the vertical frames 111 at both sides, each of the vertical frames including an internal support plate 111a protruding horizontally and inwardly from the lower end and an outer protrusion plate 111b protruding outwardly from the upper end;
a crane 2 having a boom support 21 that is mounted on the center of the body frame 11 and can be rotated by a rotation driving unit 211, a boom 22 that has a rear end connected to the boom support 21 so that an angle can be changed by an angle changing cylinder 211 and includes a boom extension and retraction cylinder and a winch 223, and a hook wire 13 that is wound around the winch 223 and released downward from the front end of the boom 22 and includes a hook 231 at the end;
a front recharging unit 3 that is disposed at the front area between the vertical frames 111 at both sides and on which a lot of rechargeable batteries B are mounted;
a rear recharging unit 4 that is disposed at the rear area between the vertical frames 111 at both sides and at the upper part of the rear area of the vehicle body 1, and on which a lot of rechargeable batteries B are mounted;
a plurality of outriggers 5 that are provided at both sides of the front and rear area of the body frame 11, and each of which is inclined downward from the top to the outside;
a hydraulic fluid supply unit 6 that is disposed at the center of one side of the vehicle body 1 and supplies a hydraulic fluid to the wheel driving motor, the rotation driving unit 211, the angle changing cylinder 221, the boom extension and retraction cylinder, the winch 223, and each of the outriggers 5; and
a driving seat 7 that is disposed at the center of the other side of the vehicle body 1 and in which a driver is able to sit to manipulate and control the wheel driving motor, the rotation driving unit 211, the angle changing cylinder 221, the boom extension and retraction cylinder, the winch 223, each of the outriggers 5, and the hydraulic fluid supply unit 6.

2. The self-propelled type crane of claim 1,
wherein the outrigger 5 includes a cylinder 51 that is inclined with respect to and fixed to the vehicle body 1 and has a rod protruding from the lower part, and
a contact plate 52 that is coupled by a hinge shaft 53 to the lower part of the rod so that the angle can be changed and that contacts the road surface.

3. The self-propelled type crane of claim 1,
wherein the hydraulic fluid supply unit 6 includes a mounting space 61 that is formed at a central part of one side of the vehicle body 1 and is indented so that the outer and upper parts are open,
a fluid tank 62 that is insertedly mounted into the mounting space 61,
two hydraulic pumps 63, within the fluid tank 62, that are connected by fluid lines to the wheel driving motor, the rotation driving unit 211, the angle changing cylinder 221, the boom extension and retraction cylinder, the winch 223, and each of the outriggers 5, and
two electric motors 64, at the top of the fluid tank 62, that are directly connected to the rotation shaft of each of the hydraulic pumps 63 and are connected to the driving seat 7 so that the electric motors 64 are provided with electricity from the front recharging unit 3 or rear recharging unit 4 by external manipulation, and
a cover material 65 that covers the outer and upper parts of the mounting space 61 by opening and closing.

4. The self-propelled type crane of claim 3,
wherein the driving seat 7 includes a driving space 71 that is formed at a central part of the other side of the vehicle body 1 so that the outer and upper parts are open,
a seat 711 that is provided at the driving space 71 and at which a driver sits while looking ahead,
a steering wheel 72 that is provided at the front part of the driving space 71 and connected to the steering device,
a manipulation and control unit 73 that is provided within the driving space 71 and manipulates and controls the wheel driving motor, the rotation driving unit 211, the angle changing cylinder 221, the boom extension and retraction cylinder, the winch 223, each of the outriggers 5, and the two electric motors 64,
an accelerator pedal 75 that is provided at the lower part of the driving space 71 to control the rotative force of the electric motor 64, and
an upper safety cover 74 that covers the upper part of the driving space 71.

5. The self-propelled type crane of claim 1,
wherein the front recharging unit 3 includes a front support plate 31 that has both ends fixedly contact the upper part of the internal support plate 111a of the vertical frames 111 at both sides and stores a lot of rechargeable batteries B at the upper part, and
a cover plate 32 that covers the upper part between the vertical frames 111 at both sides.

6. The self-propelled type crane of claim 1,
wherein the rear recharging unit 4 includes a rear support plate 41 that has both ends fixedly contact the upper part of the internal support plate 111a of the vertical frames 111 at both sides and stores a lot of rechargeable batteries B at the upper part,
two rear horizontal side plates 42 that have each end fixed on the upper surface of the outer protrusion plate 111b of the vertical frames 111 at both sides, are fixed to the vertical frames 111 at both sides in an outward horizontal direction, and the upper part of which stores a lot of rechargeable batteries, and
a rear cover material 43 that is provided at the upper part of the rear area of the vehicle body 1 and covers the rechargeable batteries B that are loaded, and wherein the rear cover material 43 is configured to open and close, and is in the shape of a rectangular parallelpipe with a lower part open.
